(19) United States
(12) Patent Application Publication
(10) Pub. No.: US 2009/0211534 A1
(43) Pub. Date: Aug. 27, 2009

(54) System for Small Animal Aerosol Inhalation Chamber

(75) Inventors: Alan Rowe Schenkel, Fort Collins, CO (US); William Glen Schroeder, Denver, CO (US); John Volckens, Fort Collins, CO (US)

Correspondence Address: Alan R. Schenkel, Ph.D., 1800 Manchester Drive, Fort Collins, CO, 80526, US

(73) Assignee: Alan Rowe Schenkel, For Collins, CO (US)

(21) Appl. No.: 12/364,493

(22) Filed: Feb. 2, 2009

Related U.S. Application Data
(60) Provisional application No. 61/030,692, filed on Feb. 22, 2008.

(51) Int. Cl. A01K 1/03

(52) U.S. Cl. 119/420

(57) ABSTRACT

This patent application is for an apparatus to safely expose guinea pigs and other small animals to biohazardous aerosol. It is composed of three main chambers housed in an outer box which fits within a conventionally sized biosafety cabinet. The animal chamber contains a removable housing unit for four or eight guinea pigs. The aerosol chamber is separate to minimize fur contamination. The nebulizer chamber is also sealed to reduce risks from leakages. This apparatus is easily decontaminated by immersion in disinfectant. The first version of the prototype, tentatively named the AXS1, has been tested for safety, ergonomics, efficiency of rodent exposure to bacteria, airflow, access points, seal mechanisms, and size.

### BACKGROUND OF THE INVENTION

The most common apparatus in use in use is a very large complex system called the Madison Chamber (University of Wisconsin, Madison, Wis.). Unfortunately the Madison chamber is not easily decontaminated and has a few accidents due to leaks or decontamination issues (http://www.sunshine-project.org/publications/pr/pr180405.html). It's complexity and system of tubes and seals makes it susceptible to leaks at at several points. We designed and tested a simpler apparatus that can be easily decontaminated and inspected for leaks.

### BRIEF SUMMARY OF THE INVENTION

This patent application is for an apparatus to safely expose guinea pigs and other small animals to biohazardous aerosol. This apparatus is easily decontaminated by immersion in disinfectant and small enough to be operated within a biosafety cabinet. The apparatus is composed of three interior chambers with a removable animal restrainer. The complete system includes a nebulizer, air flow regulator, pressure gauge, and pump station.

### BRIEF DESCRIPTION OF THE SEVERAL VIEWS OF THE DRAWING

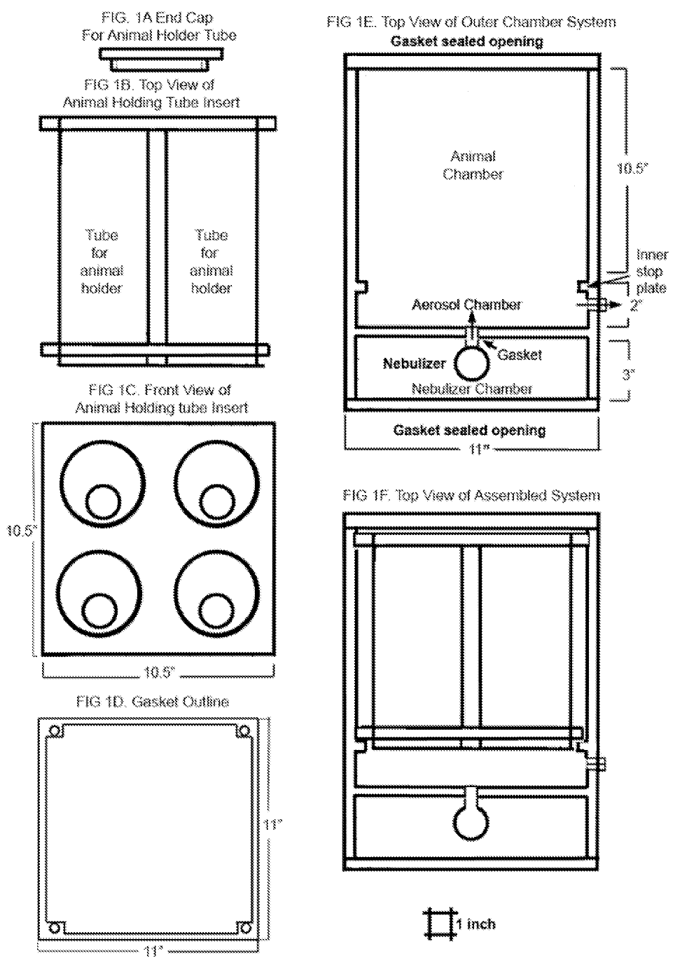

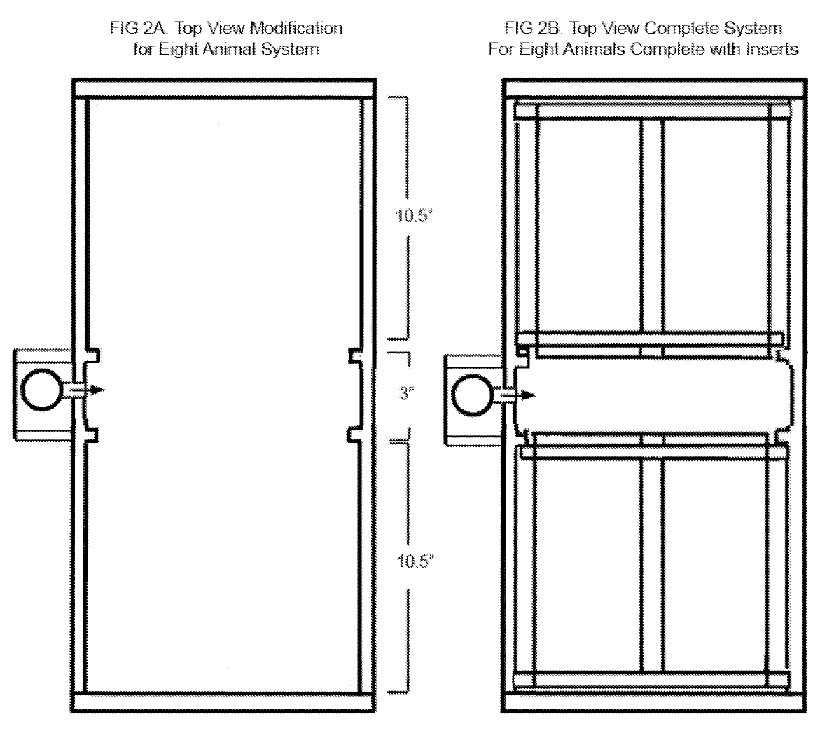

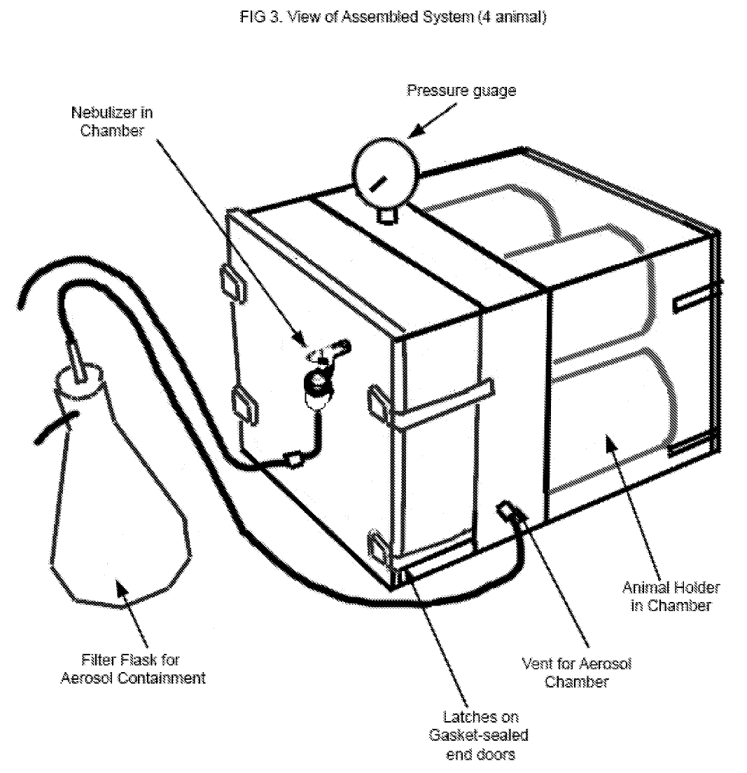

As shown in FIG. 1, the AXSL i smaller (11″×11″×18.5″) so that one or two units may fit within a conventional biosafety cabinet. The apparatus has a removable section where the animals are contained. The eight animal system has two animal chambers (FIG. 2) This fits into a larger gasket sealed box which contains the aerosol chamber and nebulizer chamber (FIGS. 1-2). Both ends are closed with clamp fittings and sealed by silicon gaskets (FIG. 3). The latches have a secondary safety catch to prevent accidental opening.

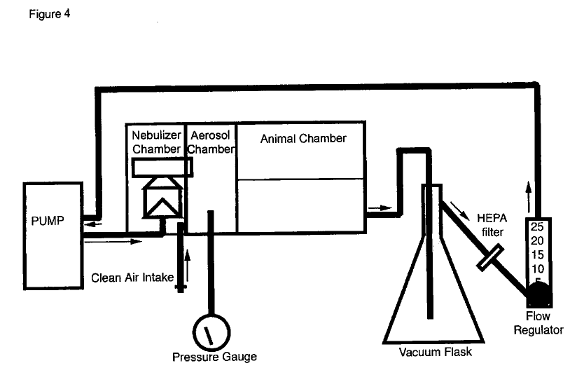

A vacuum flask is used to collect the aerosol into chemical disinfectant and any air is filtered by an in-line high efficiency particulate air (HEPA) filter (FIG. 4). The nebulizer is a conventional air jet nebulizer, driven by an air pump system that has both output and intake ports. Air flow is controlled by an in line regulator also separated by the HEPA filter.

### DETAILED DESCRIPTION OF THE INVENTION

Construction: The box and the insert are constructed of acrylic plastic, although polycarbonate can also be used. As shown in FIG. 1, the AXS1 is 11 inches×11 inches×18.5 inches. The This current design is for four guinea pigs (FIGS. 1, 3) and eight guinea pigs (FIG. 2). The Piece B fits into a larger gasket sealed box which contains the aerosol chamber and nebulizer chamber. Both end lids are closed with clamp fittings and sealed by silicon gaskets.

A vacuum flask is used to collect the aerosol and any air is filtered by an in-line high efficiency particulate air (HEPA) filter (FIG. 4). The nebulizer is a conventional air jet nebulizer, driven by an air pump system that has both output and intake ports. Air flow is controlled by an in line regulator. Flow rate with this system is six liters per minute.

### Additional Parts:

Medical air-jet nebulizer: part no. 9911-1 A Helping Hand HealthMed Benicia, Calif.
Adaptor pipe: 15×22 mm Hospitak part no. 962-E, Hospitak Inc. Farmingdale, N.Y.
Barnant Pump station: catalog no. 13-875-240, Fisher Scientific, Waltham, Mass.
Air regulator: catalog no. EW-32460-48, Cole Parmer, Vernon Hills, Ill.

Safety in filters. One of the accidents caused by the Madison chamber was due to a leaky airflow meter (http://www.sunshine-project.org/publications/pr/pr180405.html). The airflow meter in this design is not exposed to infectious aerosol and is separated by a 0.2 micron HEPA filter.

Chemical resistance of all components for cleaning and disinfection. Another accomplishment is the minimized metallic content. In consultation with Cole-Parmer (Vernon Hills, Ill.) and Accurate Gasket (Denver, Colo.) about the best materials for the disinfection agents anticipated to be used (e.g. quaternary alkyl ammonium chlorides, hydrogen peroxide), the system components have been optimized to withstand any degradation caused by cleaning and disinfection.

“Quick connect” hosing connections. The intake and outtake hose connections has “quick connect” hosing connections that seal when open to minimize any leakages.

Disposability. Many pieces of the new design will take advantage of this disposability, where any part with any question as to its safety or structural integrity can easily be replaced with minimal cost.

Port seals. The design also require three “ports” each of which are potential leak points. Tapped, threaded ports are also glued so that the permanent connection points are sealed.

These will then have quick connect hose connections that also seal to minimize any potential leak points. The installation of the sanitary gauge is also one remaining challenge as it is the only metallic component of the system.

Fur contamination. Although the Madison Chamber and most other animal aerosol exposure systems do not address this issue, the tube design should minimize most fur contamination just to the very front of the animals. One possibility is to place the animals within heavy plastic cones so that only the nose and mouth are directly exposed but first the extent of fur contamination will be assessed with the current system.

### Safety Testing

Initial tests of the excised lungs for Xenogen IVIS detection of luciferase expressing bacteria have been completed. However, the low amounts of Mycobacterium tuberculosis bacteria used typically by some research groups may mean that 100 or less bacteria per lung may not be detectable immediately after exposure. An incubation period has been added to the protocol. Alternative testing using nuclear magnetic resonance imaging (MRI) may be necessary to visualize granulomas formed after incubation in the final experiment.

Leak testing. Prior testing protocols used fluorescein accumulation to detect leaks in the system. The current design has a distinct advantage as it allows simple whole system water flooding tests to detect any leakage points.

1. We claim that this novel aerosol exposure apparatus and design, called the AXS, has the following features and attributes:
(a) safety as it's first priority for users by using three interior chambers (animal, nebulizer, and aerosol) contained within an outer box, which in turn sized to fit within a conventionally sized biosafety cabinet (approximately three feet X four feet X three feet interior chamber);
(b) the three chambers have the following attributes:
(i) the nebulizer chamber is separated and sealed to prevent accidental leaks,
(ii) the aerosol chamber which has the outtake port, clean air port, and pressure gauge port,
(iii) the animal chamber (s) which has a removable animal housing, holding four per guinea pigs per chamber;
(c) the system also has the following attributes:
(iv) HEPA filtered containment of exhaust into a filter flask with chemical disinfectant,
(v) chemically inert seals,
(vi) pressure gauge and air flow regulator separated from the chamber by a HEPA filter,
(vii) latches with secondary safety catches to prevent accidental opening;
(d) the apparatus is easily decontaminated by immersion in disinfectant.
